(19) United States
(12) Patent Application Publication
(10) Pub. No.: US 2018/0355189 A1
(43) Pub. Date: Dec. 13, 2018

(54) ANTI-BIOFOULING COATING BASED ON EPOXY RESIN AND AMINE-FUNCTIONAL POLYSILOXANE

(71) Applicants: Dow Global Technologies LLC, Midland, MI (US); Rohm and Haas Company, Philadelphia, PA (US)

(72) Inventors: Yan Huang, Shanghai (CN); Hongyu Chen, Zhangjiang (CN); Xinyu Cao, Shanghai (CN); Yu Zhang, Shanghai (CN); Paul J. Popa, Auburn, MI (US); Yuteng Lin, Shanghai (CN); John A. Roper, Midland, MI (US); Gerald A. Vandezande, Raleigh, NC (US)

(21) Appl. No.: 16/060,085

(22) PCT Filed: Dec. 30, 2015
(86) PCT No.: PCT/CN2015/099767

§ 371 Date: Jun. 7, 2018

(51) Int. Cl. C09D 5/16; C09D 163/00; C08G 59/56; C08G 59/66; C08G 77/26

(52) U.S. Cl. CPC C09D 5/1675; C09D 163/00; C09D 5/1637; C08G 59/66; C08G 77/26; C08G 59/56

(57) ABSTRACT

Curable coating compositions for preventing biofouling include a) at least one epoxy resin; b) at least one amine-functional poly(dialkylsiloxane) polymer in an amount from 1 to 70% based on the combined weights of components a) and b); and c) at least one alkylene polyamine, polyalkylene polyamine or polymercaptan epoxy curing agent; wherein components b) and c) together provide about 0.75 to 1.5 equivalents of amine nitrogen atoms and/or thiol groups per equivalent of epoxy groups provided by component a). When cured to form an antifouling coating, the coating exhibits a water contact angle of at least 100° as measured using an optical contact angle meter at 22° C. The coating composition adheres well to many substrates, provides good anticorrosion protection and is an effective anti-biofouling measure.

This invention relates to anti-biofouling marine coatings, methods of applying such coatings, and to methods for reducing biofouling.

Biofouling is the accumulation of living organisms such as barnacles, mussels and other shellfish, algae and bacteria onto submerged surfaces, such as the hulls of ships. The biofouling can cause a number of problems. On ship hulls, biofouling increases drag, reducing the maximum attainable speed and increasing fuel consumption. Periodic dry-docking is needed to remove the accumulated biological materials and residues such as mollusk shells. Biofouling leads to the introduction of invasive species when marine vessels transport the attached biological species to new locales. In other marine structures, biofouling can cause problems such as added weight (which can cause structural failure) restricting access to functional components of the structure, and interfering with mechanical operations. The accumulated biological material often produces an abrasive surface with many sharp points or edges. Such abrasive surfaces are injurious to people and wildlife, and damaging to ropes and other materials.

In non-marine situations, biofouling can occur, for example, in water pipelines, in appliances such as washing machines, laundry tubs, dishwashers, bathtubs, other fluid storage vessels, sewage lines, water channels, agricultural water storage and handling systems, and in other places which are exposed to untreated water. The biofouling can require frequent cleaning, and may result in odors as well as health and toxicity concerns.

Coatings are used to control biofouling. These fall mainly into two type. The first type contains a biocide or other toxin that kills or repels the living organisms. These have the disadvantage of toxicity to other organisms (including humans) and the potential for bioaccumulation.

The second type of coating produces a low energy “non-stick” surface. Coatings of this type often include a polydimethylsiloxane polymer. A problem with these coatings is although biological organisms adhere poorly to them, so do the marine structures themselves. These coatings therefore tend to slough off from the marine structure. Another problem with these coatings is they tend to be very soft materials that erode away rapidly.

Because of these problems, the polydimethylsiloxane-based coatings tend to have short lives, and must be re-applied frequently, at significant cost.

In addition, the polydimethylsiloxane-based coatings are not very effective in preventing corrosion to the underlying structure.

Because of the shortcomings of polydimethylsiloxane-based coatings, it has become common to use them as the outermost layer of a multi-layer coating system. These commonly include a first epoxy coating, which provides strong adhesion and good anti-corrosion protection to the substrate. A “tie-layer” is applied on top of the epoxy coating to help bond the epoxy layer to a surface non-stick layer. See, for example, US 2007-0092738 and US 2008-0138634. Systems of this type are effective in providing anti-corrosion protection and reducing biofouling. However, these systems require multiple coating layers to be applied and cured, which leads to prolonged dry-docking times and large coating costs.

Attempts have been made to simplify the coating system into two- or even one-layer coatings. U.S. Pat. No. 5,691,019 describes a two-layer system having a base anticorrosion layer and a top polydimethylsiloxane layer. The base layer may contain, for example, an amino-functional polysiloxane and an epoxy resin. The base layer is not described as having antifouling attributes; to the contrary, an additional top layer is needed to supply those characteristics. The base layer functions as an anticorrosion and tie layer. U.S. Pat. No. 5,904,959 describes a coating composition that includes an epoxy resin, an epoxy-modified polysiloxane and a curing agent. When cured, this coating composition is said to form an antifouling coating.

An antifouling coating that effectively reduces biofouling, provides good anticorrosion protection, has good mechanical properties and adheres strongly to a variety of structural materials is desired.

This invention is in one aspect a method of forming an antifouling coating on a substrate, comprising applying a curable coating composition to an exposed surface of the substrate and curing the curable coating composition to form the antifouling coating adherent to the substrate, wherein the coating composition includes a liquid phase that contains:

a) at least one epoxy resin

b) at least one amine-functional polysiloxane (AFPS) in an amount from 1 to 70% based on the combined weights of components a) and b); and

c) at least one alkylene polyamine, polyalkylene polyamine or polymercaptan curing agent;

wherein components b) and c) together provide about 0.75 to 1.5 equivalents of amine nitrogen atoms and/or thiol groups per equivalent of epoxy groups provided by component a), and the antifouling coating exhibits a water contact angle of at least 100° as measured using an optical contact angle meter at 22° C. with 5 μL droplets.

In a second aspect, the invention is a method of forming an antifouling coating on a substrate, comprising applying a curable coating composition to an exposed surface of the substrate and curing the curable coating composition to form the antifouling coating adherent to the substrate, wherein the coating composition is a mixture of:

a) an epoxy resin component, which epoxy resin component has a liquid phase that includes 1) an epoxy group-containing reaction product of i) at least one polyepoxide or a mixture of polyepoxides, and ii) at least one amine-functional polysiloxane (AFPS); and

b) a curative component including at least one alkylene polyamine, polyalkylene polyamine or polymercaptan curing agent, in an amount to provide about 0.75 to 1.5 equivalents of amine nitrogen atoms and/or thiol groups per equivalent of epoxy groups in the epoxy resin component,

the antifouling coating exhibiting a water contact angle of at least 100° as measured using an optical contact angle meter at 22° C. on 5 μL droplets.

The invention is also a liquid, epoxy group-containing reaction product of i) at least one polyepoxide or a mixture of polyepoxides, and ii) at least one amine-functional polysiloxane (AFPS).

The invention is also a two-part epoxy resin coating composition comprising an epoxy resin component and a curative component, wherein the epoxy resin component has a liquid phase that includes 1) an epoxy group-containing reaction product of i) at least one polyepoxide or a mixture of polyepoxides, and ii) at least one amine-functional polysiloxane and optionally 2) at least one additional epoxy resin; and the curative component includes at least one alkylene polyamine, polyalkylene polyamine or polymercaptan curing agent.

Coatings made in accordance with the invention bond strongly to many substrates, yet when cured have very low surface energies and therefore form highly effective protective and antifouling coatings. Because of this combination of properties, it is only necessary to provide a single-layer coating (or multiple layers of the coating, if a thicker coating layer is wanted) to obtain both good protection against corrosion and antifouling properties. It is not necessary to apply separate anticorrosion, tie and antifouling layers.

The FIGURE is a front schematic view of a modified test assembly for measuring pull-off stress.

The epoxy resin(s) each should have an average of at least 1.8 epoxide groups per molecule, and may contain an average of up to 20, up to 10, up to 5 or up to 4 epoxide groups per molecule. If a single epoxy resin is present, its epoxy equivalent weight preferably is up to 300, such as 100 to 250 and or 150 to 250. If a mixture of epoxy resins is present, the epoxy equivalent weight of the mixture preferably is up to 300 and is may be 100 to 250 and or 150 to 250. The epoxy resins may contain aromatic groups, or may be aliphatic and/or cycloaliphatic compounds that do not contain aromatic groups.

Examples of aromatic epoxy resins include diglycidyl ethers of polyhydric phenol compounds such as resorcinol, catechol, hydroquinone, biphenol, bisphenol A, bisphenol AP (1,1-bis(4-hydroxylphenyl)-1-phenyl ethane), bisphenol F, bisphenol K and tetramethylbiphenol and polyglycidyl ethers of phenol-formaldehyde novolac resins (epoxy novolac resins), alkyl substituted phenol-formaldehyde resins, phenol-hydroxybenzaldehyde resins, cresol-hydroxybenzaldehyde resins, dicyclopentadiene-phenol resins and dicyclopentadiene-substituted phenol resins. Commercially available aromatic epoxy resins that are useful in the invention include diglycidyl ethers of bisphenol A resins such as are sold by Dow Chemical under the designations D.E.R.® 330, D.E.R.® 331, D.E.R.® 332, D.E.R.® 383, D.E.R. 661 and D.E.R.® 662 resins; and epoxy novolac resins such as those sold as D.E.N.® 354, D.E.N.® 431, D.E.N.® 438 and D.E.N.® 439 from Dow Chemical.

Examples of useful aliphatic and/or cycloaliphatic epoxy resins include diglycidyl ethers of aliphatic glycols such as the diglycidyl ethers of C₂₋₂₄ alkylene glycols, diglycidyl ethers of cyclohexanedimethanol and diglycidyl ethers of polyether polyols; cycloaliphatic epoxy resins, and any combination of any two or more thereof. A cycloaliphatic epoxy resin is one in which two adjacent aliphatic ring carbons form part of the epoxide group.

Suitable cycloaliphatic epoxy resins include those described in U.S. Pat. No. 3,686,359, incorporated herein by reference. Cycloaliphatic epoxy resins of particular interest are (3,4-epoxycyclohexyl-methyl)-3,4-epoxy-cyclohexane carboxylate and bis-(3,4-epoxycyclohexyl) adipate, polymers of vinyl cyclohexene monoxide and mixtures thereof.

Other suitable epoxy resins include oxazolidone-containing compounds as described in U.S. Pat. No. 5,112,932. In addition, an advanced epoxy-isocyanate copolymer such as those sold commercially as D.E.R. 592 and D.E.R. 6508 (Dow Chemical) can be used.

Each of the epoxy resin(s) by themselves may be liquid or solid at 23° C. If a mixture of epoxy resins is present, the mixture of epoxy resin(s) by itself may be liquid or solid at 23° C.

The amine-functional polysiloxane (AFPS) is a polysiloxane polymer or copolymer that has at least one primary or secondary amino group. It preferably contains at least 2, especially 2 to 4 or 2 to 3, primary or secondary amino groups per molecule. The amino groups can be terminal or pendant. Most preferably, the AFPS contains 2 terminal primary or secondary amino groups per molecule.

The AFPS may have an equivalent weight per primary and/or secondary amino group of, for example, from 350 to 30,000. In specific embodiments, this equivalent weight may be at least 500 or at least 1000, and may be up to 10,000, up to 5,000 or up to 3000.

In specific embodiments, the AFPS may have a number average molecular weight of at least 700, at least 1000 or at least 2000, up to 60,000, up to 50,000, up to 25,000, up to 10,000 or up to 5,000.

The AFPS contains repeating

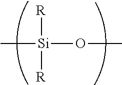

units, where the R groups are independently unsubstituted or substituted alkyl or aryl, especially methyl or phenyl groups and most preferably phenyl groups. Substituents are non-reactive with amino groups, epoxy groups and the epoxy curing agent, and do not bond to another polysiloxane chain.

The AFPS may be, for example, a linear polysiloxane; a branched polysiloxane, a linear or branched block or graft copolymer having at least one polysiloxane block and one or more blocks of a vinyl polymer and/or a polyether. Block and graft copolymers as described in U.S. Pat. No. 6,440,572 are suitable if modified to include amino groups.

Useful AFPSs include commercially available products such as Xiameter OFX-8630 from Dow Corning Corporation, Midland, Mich.) and DMS-A11, DMS-A15, DMS-A21, DMS A211, DMS-A31, DMS-A32 and DMS-A35 aminosiloxanes from Gelest Inc., Morrisville, Pa.

The AFPS may constitute, for example, 1 to 75 percent of the combined weights of the epoxy resin(s) and AFPS. In some embodiments, this amount is 1 to 30 percent, 5 to 30 percent, 5 to 20 percent or 5 to 15 percent, on the same basis.

The curing agent is an alkylene polyamine, polyalkylene polyamine, a polymercaptan, or a mixture of two or more thereof.

An alkylene polyamine or polyalkylene polyamine curing agent has at least 2 amine nitrogen atoms, and may have up to 10 amine nitrogen atoms. Alkylene polyamines include, for example, ethylene diamine, 1,2-propylene diamine, 1,3-propylene diamine, 1,4-butanedamine, 1,2-butane diamine, 1,6-hexamethylene diamine, and the like. Polyalkylene polyamines include, for example, diethylene triamine, triethylene tetraamine, tetraethylene pentaamine, various polypropylenepolyamines, and the like.

Polymercaptan curing agents contain at least two mercaptan groups per molecule, and may contain as many as 20, as many as 10 or as many as 6 mercaptan groups per molecule. Examples of polymercaptan curing agents include, for example, esters of monomercaptancarboxylic acids with polyhydric alcohols, esters of monomercaptanmonohydric alcohols with polycarboxylic acids, and other ester-containing polymercaptans as described in U.S. Pat. No. 4,126,505. Another useful type of polymercaptan is a propoxylated ether polythiol, such as described in U.S. Pat. No. 4,092,293. Also useful are polymercaptan-containing resins having a molecular weight of 750 to 7000 as in described in U.S. Pat. No. 3,258,495, dimercaptopolysulfide polymers as described in U.S. Pat. No. 2,919,255, thiolated triglycerides and thiolated oligomeric triglycerides having molecular weights of up to 20,000, and the like.

Other suitable polymercaptan curing agents include 1,2,3-tri(mercaptomethyl) benzene, 1,2,4-tri(mercaptomethyl) benzene, 1,3,5-tri(mercaptomethyl) benzene, 1,3,5-tri(mercaptomethyl)-4-methyl benzene, 1,2,4-tri(mercaptoethyl)-5-isobutyl benzene, 1,2,3-tri(mercaptomethyl)-4,5-diethyl benzene, 1,3,5-tri(mercaptomethyl)-2,6-dimethyl benzene, 1,3,5-tri(mercaptomethyl)-4-hydroxy benzene, 1,2,3-tri(mercaptobutyl)-4,6-dihydroxy benzene, 1,2,4-tri(mercaptomethyl)-3-methoxy benzene, 1,2,4-tri (mercaptoethyl)-4-aminoethyl benzene, 1,3,5-tri(mercaptobutyl)-4-butoxy benzene, 1,2,4,5-tetra(mercaptomethyl)-3,6-dimethyl benzene, 1,2,4,5-tetra(mercaptoethyl)-3,6-dimethoxy benzene, 1,2,4-tri(mercaptomethyl)-3-(N,N-dimethylamino) benzene, 1,3,5-tri (mercaptobutyl)-4-(N,N-dibutylamino) benzene, 1,2,4,5-tetra(mercaptomethyl)-3,6-dihydroxy benzene, 3,4,5-tri(mercaptomethyl) furan, 2,3,5-tri(mercaptoethyl) furan, 2-butyl-3,4,5-tri(mercaptomethyl) furan, 3,4,5-tri(mercaptomethyl) thiophene, 2,3,5-tri (mercaptomethyl)thiophene, 2-isobutyl-3,4,5-tri(mercaptoethyl) thiophene, 3,4,5-tri (mercaptobutyl)pyrrole, 2,3,5-tri (mercaptomethyl)pyrrole, 2,4,6-tri(mercaptomethyl) pyridine, 2,3,5-tri(mercaptomethyl) pyridine, 2,4,6-tri(mercaptomethyl)-5-butyl pyridine, 2,4,6-tri(mercaptomethyl-5-vinyl pyridine, 2,3,5-tri(mercaptobutyl)-4-allyl pyridine, 2,3,5-tri(mercaptomethyl) thionaphthene, 2,3,5-tri(mercaptomethyl) quinolone, 3,4,6-tri(mercaptomethyl) isoquinoline, 4-mercaptomethylphenyl-4′,5′-dimercaptomethylphenylmethane, 2,2-bis (4,5-dimercaptomethylphenyl) propane, 2,2-bis(4,6-dimercaptobutylphenyl) butane, 4-mercaptomethylphenyl-3′,4′-dimercaptomethylphenyl oxide, 4-mercaptomethylphenyl-3′,4′-dimercaptomethylphenyl sulfone, 2,2-bis (4,5-dimercaptoethylphenyl) sulfide, the 3,4-dimercaptomethylphenyl ester of carbonic acid, the 3,4-dimercaptoethylphenyl ester of maleic acid, 1,3,5-tri (mercaptomethyl)-2,4,6-trimethylbenzene, 2,2-bis(3-butyl-4,5-dimercaptoethylphenyl) hexane, 1,3,5-tri(4-mercapto-2-thiabutyl) benzene, 1,3,5-tri(4-mercapto-2-oxabutyl) benzene, 2,3-bis(4,5-dimercaptobutyl-3-chlorophenyl) butane, 4-mercaptobutylphenyl-3′,4′-dimercaptomethylphenyl oxide, 3-mercaptobutylphenyl-2′,4′-dimercaptobutylphenyl oxide, di(3,4-dimercaptohexyl) ether of 2,2-bis (4-hydroxyphenyl) sulfone, di(3,4-dimercaptobutyl) ether of 2,2-bis(4-hydroxy-5-methoxyphenyl) 1,1-dichloro-propane, di (2,3-dimercaptopropyl) phthalate, di(3,4-dimercaptobutyl) tetrachlorophthalate, di(2,3-dimercaptopropyl) terephthalate, di(3,4-dimercapthexyl) adipate, di(2,3-dimercaptobutyl) maleate, di(2,3-dimercaptopropyl) sulfonyldibutyrate, di(3,4-dimercaptooctyl) thiodipropionate, di(2,3-dimercaptohexyl) citrate, di(3,4-dimercap-toheptyl) cyclohexanedicarboxylate, poly(2,3-dimercaptopropyl) ester of polyacrylic acid and poly(2,3-dimercaptohexyl) ester of polymethacrylic acid.

The first and second aspects of the invention differ primarily in how the AFPS is incorporated into the epoxy resin composition.

In the first aspect of the invention, the AFPS is blended together with the epoxy resin and curing agents, and all of the components are cured at once. In those embodiments, the AFPS can be formulated into a curative component with the curing agent(s), or added into the epoxy resin component individually.

The blended epoxy resin(s), AFPS and curing agents form a liquid epoxy resin phase. If any of these components is a room temperature solid, or if the combination of the components is a room temperature solid, the liquid epoxy resin phase should contain a solvent in which components a), b) and c) are dissolved to form the liquid phase.

The solvent is an organic compound in which the epoxy resin(s), AFPS(s) and curing agent(s) form a solution that is liquid at 23° C. and does not phase separate into layers when left at unstirred at room temperature for one hour. The solvent is conveniently an organic compound having a boiling temperature of 35 to 150° C., more preferably 40 to 100° C. Examples of suitable solvents include, for example, reactive diluents such as such as n-butyl glycidyl ether, isopropyl glycidyl ether and phenyl glycidyl ether; aromatic compounds such as benzene, toluene and xylene; ketones such as acetone and methyl ethyl ketone, halogenated alkanes such as 1,1,1-trichloroethane, chloroform, carbon tetrachloride and 1,2-dichlorethane, and glycol ethers.

The amount of solvent may be, for example, 1 to 75 percent of the combined weight of components a), b), c) and the solvent.

A solvent preferably is present even if components a), b) and c) are all room temperature liquids. In such a case, the solvent can reduce the viscosity of the liquid phase and/or help prevent the starting materials from phase separating after they are mixed but before they cure.

Similarly, one or more surfactants may be present in the liquid phase to prevent or reduce the tendency of the starting materials to phase separate. Examples of useful surfactants include polydimethylsiloxane-polyethylene oxide copolymers, and other silicone and fluorinated silicone surfactants.

In the first aspect of the invention, components a), b) and c), together with any solvent(s) and/or surfactants as may be used and any optional ingredients as described below, are formed into a mixture. The order of mixing is generally not critical provided that curing does not take place prematurely. It is generally preferably to mix in the AFPS and the curing agents(s) shortly before applying the mixture to form a coating, to prevent premature curing. In forming this mixture, the AFPS and the curing agent(s) (components b) and c)) together provide (prior to curing) about 0.75 to 1.5 equivalents, preferably 0.9 to 1.25 equivalents, of amine nitrogen atoms and/or thiol groups per equivalent of epoxy groups provided by the epoxy resin(s).

Methods for forming the coating and curing it are described more fully below.

In the second aspect of the invention, the AFPS is prereacted with at least a portion of the epoxy resin(s) to form an epoxide-containing prepolymer, and thus forms a part of the epoxy resin component prior to combining it with the curing agent(s).

The prereaction is performed with an excess of epoxy resin, so the product of the prereaction contains epoxy groups. The prereaction can be performed by combining the AFPS with at least two equivalents of the epoxy resin(s) per equivalent of amino groups in the AFPS. If a greater quantity of epoxy resin is present during this prereaction, the prereaction product typically will contain the epoxy resin/AFPS reaction product plus some quantity of unreacted epoxy resin.

The prereaction can be performed in the presence of an epoxy curing catalyst if desired, and also in the presence of a solvent and/or surfactant as described before. The prereaction can be performed at temperatures as low as about 20° C., but elevated temperatures up to about 100° C. are often preferred to obtain a faster reaction.

If the prereaction is done with only a portion of the epoxy resins, the remaining epoxy resin(s) are then combined with the product of the prereaction.

If the epoxy resin/AFPS reaction product or mixture thereof with additional epoxy resin is not a room temperature liquid, a solvent is present to dissolve those materials and form a liquid phase. As before, a solvent may be present even if those materials are not liquid, to reduce viscosity or for other reasons.

To form the coating composition, the epoxy resin/AFPS reaction product, any additional epoxy resin(s), and the curing agent are combined. It is generally convenient to formulate the starting materials into a two-part epoxy resin coating composition that includes an epoxy resin component and a curative component. The epoxy resin component includes the epoxy-functional material(s), and the curative component includes the curing agent(s). In such a case, the coating composition is formed by combining the epoxy resin and curative components.

In the second aspect of the invention, the curing agent(s) by itself provides (prior to curing) about 0.75 to 1.5 equivalents, preferably 0.9 to 1.25 equivalents, of amine nitrogen atoms and/or thiol groups per equivalent of epoxy groups in the liquid epoxy resin phase (including the epoxy groups provided by the epoxy resin/AFPS reaction product as well as those provided by an additional epoxy resin component as may be present).

A coating composition of the invention may contain various optional components, in addition to the ingredients already described. One preferred such ingredient is one or more epoxy curing catalyst(s), which catalyzes the reaction of an epoxide with an amine or a mercaptan. Useful epoxy curing catalysts include, for example, cyclic imidines such as 1,8-diazabicyclo[5.4.0]undecene-7 (DBU) and 1,5-diazabicyclo[4.3.0]nonene-5 (DBN) and phenolic or carboxylate salts thereof; tertiary amines such as benzyldimethylamine, 2,4,6-tris(dimethylaminomethyl)phenol and N,N-dimethylcyclohexylamine; imidazoles such as 2-ethyl-4methylimidazole and 1-cyanoethyl-2-ethyl-4-methylimidazole; phosphonium compounds such as tetraphenylphosphonium tetra (p-tolyl) borate; phosphoric esters; phosphines such as triphenylphosphine; organic metal salts such as tin octoate and zinc octoate, and various metal chelates. Any such catalysts are used in catalytically effective amounts. Typical amounts are 0.01 to 5 weight percent of the coating composition.

The adhesive may contain one or more particulates, which may function as fillers, pigments, rheology modification agents or fulfill some other purpose. The particulates may have particle sizes, for example, of up to 50 μm. These particulates may constitute, for example, 1 to 40% of the total weight of the coating composition. These are typically formulated into the epoxy resin component.

The coating composition can further contain other additives such as dimerized fatty acids, diluents, plasticizers, extenders, non-particulate colorants, fire-retarding agents, thixotropic agents, expanding agents, flow control agents, preservatives, adhesion promoters and antioxidants.

The coating composition is applied by combining all of the ingredients, forming a layer of the resulting composition onto a substrate, and curing the coating composition layer on the substrate to form an adherent coating. The method of applying the layer is not especially critical. Spraying, rolling, brushing, immersion and other conventional methods for applying a coating to a substrate are all suitable. The coating thickness may be as thin as 0.1 mil (2.54 μm) or as thick as 100 mils (2.54 mm) or more. Multiple coats can be applied to form thicker coatings as desired.

Curing can take place at temperatures from 0 to 180° C. or more. For coating large outdoor substrates, ambient temperature curing is often performed, in which the curing temperature is about 10° C. to 40° C.

The cured coating typically exhibits a water contact angle of at least 100° as measured using an optical contact angle meter at 22° C. and 5 μL water droplets. The water contact angle may be at least 105° or at least 110°.

The cured coating is an effective antifouling coating, as indicated by the pseudo-barnacle pull-off test described in the following examples. The pull-off stress required to remove fouling as measured by that test is typically no more than 20%, and often no more than 10%, of the pull-off stress required with a reference epoxy resin coating as described in the examples below. In absolute terms, the pull-off stress may be up to 1 MPa, up to 0.5 MPa or up to 0.25 MPa, according to that test.

An advantage of this invention is that it adheres strongly to many substrates, provides good protection against corrosion, but nonetheless has excellent antifouling properties. Because of this combination of properties, it can be applied directly to the substrate, without need to apply separate underlying anti-corrosion, tie or other base coats. Similarly, there is no need to apply another coating layer on top of the coating of this invention, in order to provide antifouling. Therefore, a coating of this invention can be the sole coating layer (or layers if applied in two or more coats), applied directly to the substrate and without any additional top layer being applied over this coating. Of course, the coating composition of this application may if desired be applied as one or more layers of a multi-layer system and, in such a case, may be, for example, the bottommost anticorrosion layer, a topmost antifouling layer, and/or an intermediate layer.

The substrate is not particularly limited, and can be, for example, a metal, a ceramic, concrete or cement, a polymeric material, a lignocellulosic material, any of a wide variety of composite materials, or other material capable of being coated. Of particular interest are substrates that when coated will be subjected to marine (including both seawater and freshwater) environments in which the coating will be in contact with sea- or freshwater life forms that cause fouling. These include ship hulls, buoys, barges, piers, oil and natural gas production platforms and equipment, levies, dams, retaining walls, and a wide variety of other marine equipment. Other substrates of particular interest are water pipelines, appliance surfaces such as washing machine tubs, laundry tubs, dishwasher interiors, bathtubs, swimming pools, wading pools, settling ponds, fermentation vessels, sinks other fluid storage vessels, sewage lines, water channels, agricultural water storage and handling systems, and other surfaces which are exposed to untreated water.

The following examples are provided to illustrate the invention but are not intended to limit the scope thereof. All parts and percentages are by weight unless otherwise indicated. All molecular weights are number averages unless otherwise indicated.

In the following examples:

Epoxy Resin A is a liquid diglycidyl ether of bisphenol A, having an epoxy equivalent weight of about 187.

Epoxy Resin B is an epoxy dicyclopentadiene novolac resin having an epoxy equivalent weight of about 247.

Epoxy Resin C is an epoxy novolac resin having an epoxy equivalent weight of about 179.

Epoxy Resin D is a diglycidyl ether of hydrogenated bis-phenol A. It has an epoxy equivalent weight of about 220.

Epoxy Resin E is a diglycidyl ether of cyclohexanedimethanol. It has an epoxy equivalent weight of about 155.

AFPS (amino-functional polysiloxane) A is an amine-terminated poly(dimethylsiloxane) containing 0.37% nitrogen. It has an amine equivalent weight of about 3800.

AFPS B is an aminopropyl-terminated poly(dimethylsiloxane) containing 0.6-0.7% by weight NH₂ groups. It has a molecular weight of about 5000.

AFPS C is an aminopropyl-terminated poly(dimethylsiloxane) containing 1-1.2% by weight NH₂ groups. It has a molecular weight of about 3000.

Polymercaptan A is a compound having mercaptan groups, a molecular weight of 8,000 to 15,000, an amine value of 10 to 90 and an active hydrogen equivalent weight of 190, sold as Mercaptan 9044S by Jia Di Da Co., Shenzhen, China.

TETA is a commercial grade of triethylene tetraamine.

MEK is methyl ethyl ketone.

Catalyst A is 2,4,6-tris(dimethylaminomethyl)phenol.

The Compatibilizer is a silicone surfactant marketed as L-8620 by Momentive Performance Products.

### EXAMPLE 1

2.3 parts of the polymercaptan are dissolved in MEK to form a 50% solution. Separately, 2.3 parts of Epoxy Resin A are dissolved in an equal weight of MEK. 0.14 parts of AFPS A are added to the epoxy resin solution with intensive stirring, to form a hazy mixture. The polymercaptan and epoxy resin solutions are then mixed at room temperature, stirred intensively for 5 minutes, and then placed in an ultrasonic bath for another three minutes until no droplets are visible to the naked eye. A 400 μm coating of the resulting mixture is applied to bare aluminum panels and cured at room temperature for 2 days.

The water contact angle is measured using a Franhofer OCA 20 contact angle instrument, using 0.5 μL water droplets. The contact angle is 112°.

Pseudo-barnacle pull-off testing is performed as described by Kohl et al., in “Pull-off behavior of epoxy bonded to silicone duplex coatings”, Progress in Organic Coatings, 19999, 36, pp. 15-20), using an Elcometer® pull-off strength tester with a modified test specimen as shown in the FIGURE. In the FIGURE, round aluminum studs 1 having a diameter of 10 mm at the base are glued via epoxy glue layer 2 to layer 3 of the coating of the invention on aluminum substrate 4. Epoxy glue layer 2 is a commercial epoxy adhesive which is sold under the brand name Araldite®. The epoxy glue is applied to aluminum stud 1 and then contacted with coating layer 2. The epoxy resin is cured at room temperature for 3 days. Stud 1 is then pulled from coating layer 3 in the direction indicated by arrow 5, using the Elcometer® instrument. The stress required to remove stud 1 from coating layer 3 is measured. In all cases, bond failure takes place between epoxy glue layer 2 and coating layer 3. Three replicate samples are tested and the average pull-off values of the three samples is 0.2 MPa.

### EXAMPLE 2

Example 1 is repeated using a different coating formulation. 2.1 parts of the polymercaptan are dissolved in an equal amount of MEK. The epoxy resin solution contains 1.25 parts of Epoxy Resin A, 1.1 part of Epoxy Resin B, 2.35 parts MEK and 0.24 parts of AFPS A. The water contact angle is 107° and the pseudo-barnacle pull-off stress is 0.2 MPa.

### EXAMPLE 3

Example 1 is repeated again using a different coating formulation. 1.0 part of the polymercaptan are dissolved in an equal amount of MEK. The epoxy resin solution contains 1 part of Epoxy Resin C, 1 part of MEK and 0.1 parts of AFPS A. The water contact angle is 109° and the pseudo-barnacle pull-off stress is 0.2 MPa.

### EXAMPLE 4

2.3 parts of Epoxy Resin D are dissolved in 0.74 parts MEK. 0.28 parts of AFPS B, 0.09 parts of Catalyst A and 0.02 part of the Compatibilizer are stirred together at 80° C. for 30 minutes, during which time AFPS B reacts with a portion of the epoxy resin to form a mixture of unreacted Epoxy Resin D and an epoxy-functional reaction product of Epoxy Resin D and AFPS B. After cooling to room temperature, 0.25 parts of TETA are mixed in with intensive stirring for 30 minutes. The resulting coating composition is allowed to stand at room temperature for about 5 minutes until entrained gas bubbles disappear. Coatings are made cured and tested as described in Example 1. The water contact angle is 110° and the pseudo-barnacle pull-off stress is 0.2 MPa.

### EXAMPLES 5-9 AND COMPARATIVE SAMPLE A

Example 4 is repeated, using ingredients as indicated in the following Table. Results of water contact angle measurement and pseudo-barnacle pull-off stress are measured and are as indicated in the Table. In each case, the epoxy resin and amino-function polysiloxane are combined and pre-reacted as described in Example 4.

TABLE

| | | | | | | | | Pseudo- |
|---|---|---|---|---|---|---|---|---|
| | | | | | | | | Barnacle |
| | Epoxy | AFPS | | | | | Water | Pull-Off |
| | Resin | type, | TETA, | Compat., | Catalyst, | MEK, | Contact | Stress, |
| Sample | D, wt- % | wt.- % | wt- % | Wt- % | wt- % | wt- % | Angle | MPa |
| Ex. 5 | 55.5 | B, 15.5 | 6 | 0.5 | 2.5 | 20 | 111 | 0.2 |
| Ex. 6 | 62.5 | C, 7.6 | 6.8 | 0.5 | 2.5 | 20 | 109 | 0.2 |
| Ex. 7 | 55.5 | C, 15.5 | 6 | 0.5 | 2.5 | 20 | 107 | 0.2 |
| Ex. 8 | 48.9 | C, 23.2 | 5.3 | 0.4 | 2.1 | 20 | 110 | 0.2 |
| Ex. 9 | 54.6 | B, 6.6 | 5.9 | 0.5 | 2.4 | 30 | 110 | 0.2 |
| Comp. | 74.1 | None | 5.9 | 0 | 0 | 20 | 78 | >2.5 |
| A* | | | | | | | | |

*Not an example of this invention.
“Compat.” indicates the compatibilizer.

### EXAMPLE 10

2.6 parts of Epoxy Resin E are dissolved in 0.44 parts MEK. 0.34 parts of AFPS A, 0.1 part of Catalyst A and 0.02 part of the Surfactant are stirred together at 80° C. for 20 minutes, during which time AFPS A reacts with a portion of the epoxy resin to form a mixture of an epoxy-functional reaction product of Epoxy Resin E and AFPS B, and unreacted Epoxy Resin E. A hazy mixture forms upon cooling. At room temperature, 0.5 parts of TETA are mixed in with intensive stirring for 30 minutes. The resulting coating composition is allowed to stand at room temperature for about 5 minutes until entrained gas bubbles disappear. Coatings are made cured and tested as described in Example 1. The water contact angle is 109° and the pseudo-barnacle pull-off strength is 0.2 MPa.

1. A method of forming an antifouling coating on a substrate, comprising applying a curable coating composition to an exposed surface of the substrate and curing the curable coating composition to form the antifouling coating adherent to the substrate, wherein the coating composition includes a liquid phase that contains prior to curing:
a) at least one epoxy resin;
b) at least one amine-functional poly(dialkylsiloxane) polymer in an amount from 1 to 70% based on the combined weights of components a) and b); and
c) at least one alkylene polyamine, polyalkylene polyamine or polymercaptan epoxy curing agent;
wherein components b) and c) together provide about 0.75 to 1.5 equivalents of amine nitrogen atoms and/or thiol groups per equivalent of epoxy groups provided by component a), the antifouling coating exhibiting a water contact angle of at least 100° as measured using an optical contact angle meter at 22° C.

2. The method of claim 1, wherein component c) includes a polymercaptan epoxy curing agent.

3. A method of forming an antifouling coating on a substrate, comprising applying a curable coating composition to an exposed surface of the substrate and curing the curable coating composition to form the antifouling coating adherent to the substrate, wherein the coating composition is a mixture of:
a) an epoxy resin component, which epoxy resin component has a liquid phase that includes 1) an epoxy group-containing reaction product of i) at least one polyepoxide or a mixture of polyepoxides, and ii) at least one amine-functional poly(dialkylsiloxane) polymer and
b) a curative component including at least one alkylene polyamine, polyalkylene polyamine or polymercaptan curing agent, in an amount to provide about 0.75 to 1.5 equivalents of amine nitrogen atoms and/or thiol groups per equivalent of epoxy groups in the epoxy resin component,
the antifouling coating exhibiting a water contact angle of at least 100° as measured using an optical contact angle meter at 22° C.

4. The method of claim 1, wherein component b) includes at least one polyalkylene polyamine.

5. A coated substrate made in accordance with the method of claim 1.

6. The coated substrate of claim 5, wherein the substrate is a ship hull, a buoy, a barge, a pier, an oil or natural gas production platform, a levy, a dam, a retaining wall, a water pipeline, a washing machine tub, a laundry tub, a dishwasher interior, a bathtub, a swimming pool, a wading pool, a settling pond, a fermentation vessel, a sink, a sewage line, a sewage tank, a water channel or an agricultural water storage and handling system.

7. A liquid, epoxy group-containing reaction product of i) at least one polyepoxide or a mixture of polyepoxides, and ii) at least one amine-functional poly(dialkylsiloxane) polymer.

8. A two-part epoxy resin coating composition comprising an epoxy resin component and a curative component, wherein the epoxy resin component has a liquid phase that includes the liquid, epoxy group-containing reaction product of claim 7 and optionally 2) at least one additional epoxy resin; and the curative component includes at least one alkylene polyamine, polyalkylene polyamine or polymercaptan curing agent.

9. A substrate having a cured coating on at least one surface thereof, wherein the cured coating is formed by mixing the epoxy resin component and the curative component of the two-part epoxy resin coating composition of claim 8, forming a layer of the resulting mixture on the substrate, and curing the layer to form a coating adherent to the substrate.

10. The substrate of claim 9 which is a ship hull, a buoy, a barge, a pier, an oil or natural gas production platform, a levy, a dam, a retaining wall, a water pipeline, a washing machine tub, a laundry tub, a dishwasher interior, a bathtub, a swimming pool, a wading pool, a settling pond, a fermentation vessel, a sink, a sewage line, a sewage tank, a water channel or an agricultural water storage and handling system.

11. A coated substrate made in accordance with the method of claim 3.
